(19) United States
(12) Patent Application Publication
(10) Pub. No.: US 2012/0173166 A1
(43) Pub. Date: Jul. 5, 2012

(54) TEST SYSTEM FOR TESTING A PROJECTIVE MASK

(75) Inventors: KUEICHI KUO, Shanghai (CN); Bei Zhao, Shanghai (CN)

(73) Assignee: Semiconductor Manufacturing International (Shanghai) Corporation, Shanghai (CN)

(21) Appl. No.: 13/205,617

(22) Filed: Aug. 8, 2011

(30) Foreign Application Priority Data
Dec. 29, 2010 (CN) 201010613371.9

(51) Int. Cl. G06F 19/00

(52) U.S. Cl. 702/40; 702/35

(57) ABSTRACT

A test system for testing a projective mask is provided to make an analysis based on the defect figures of the projective mask obtained by a figure capture unit and thus determine whether the quality of the projective mask meets a requirement. The test system comprises a figure analysis unit for comparing the defect figure and the target design figure corresponding to the projective mask and obtaining a bias proportion between the defect figure and the target design figure, and a test determine unit for comparing the bias proportion outputted by the figure analysis unit with a maximum permitted bias proportion. If the outputted bias proportion does not exceed the maximum permitted bias proportion, a determination that the quality of the projective mask meets the requirement is made by the test determine unit; otherwise, the test determine unit determines that the quality of the projective mask does not meets the requirement.

### CROSS-REFERENCES TO RELATED APPLICATIONS

The present application claims the priority of Chinese Patent Application No. 201010613371.9, entitled “Test System for Testing a Projective Mask”, and filed on Dec. 29, 2010, the entire disclosure of which is incorporated herein by reference.

### BACKGROUND OF THE INVENTION

1. Field of the Invention

The present invention relates generally to the field of semiconductor technology, and more particularly to a test system for testing a projective mask.

2. Description of Prior Art

Photolithography is considered as an important part of semiconductor technology, which transfers patterns on projective masks into optical resist films on the wafers using a lithography machine. To make sure the positions and shapes of patterns on the optical resist films correspond to those of patterns on the projective masks, the first step is to align using the lithography machine, as arranging alignment marks on the wafer and alignment marks on the projective masks into a line; then, the following step is to focus, as adjusting the height of the wafer in the lithography machine to make the wafer to be inside the focus range of the optical system of the lithography machine. After the align step and the focus step, exposure, as the shutter of the lithography machine is opened, ultraviolet is then emitted from the optical system of the lithography and thus the optical resist film is exposed.

To ensure that the patterns formed on the semiconductor substrate are as the same with the designed patterns as possible, firstly the quality of projective masks should be guaranteed to meet the design and process requirements and the patterns on the projective masks should conform to the design patterns. To guarantee that the quality of projective masks meet the design and process requirements, after practical photolithography process, the patterns formed in the optical resist films on the wafer are the same as the designed patterns. Since the projective masks are normally produced in the mask shop, the defects of the projective mask are unavoidable during the producing process. Thus, a test and determination process step is needed to determine whether those defects may affect the practical photolithography process and to determine whether those defects may emerge in the optical resist film so as that consequently the shape of the optical resist film may be spoiled too badly to meet the design requirements. Therefore, a test system for testing projective masks is needed, so that the quality of the projective masks can be tested to determine whether the defects on the projective masks may affect the practical photolithography process.

### BRIEF SUMMARY OF THE INVENTION

Embodiments of the present invention provide a test system for testing a projective mask, which can simulate exposure of the projective mask to test whether the projective mask is qualified and whether the defects on the projective mask may affect the practical photolithography process.

To achieve the above object, a test system for testing a projective mask is provided, configured for making an analysis based on a defect figure of the projective mask to be tested obtained by a figure capture unit and determining whether the quality of the projective mask to be tested meets a requirement of a target design figure based on result of the analysis. In an embodiment, the test system comprises:

a figure analysis unit, configured for comparing the defect figure and the target design figure corresponding to the projective mask, and obtaining a bias proportion between the defect figure and the target design figure; and

a test determine unit, configured for comparing the bias proportion outputted by the figure analysis unit with a maximum permitted bias proportion, and making a determination, wherein if the outputted bias proportion does not exceed the maximum permitted bias proportion, a determination that the quality of the projective mask meets the requirement is made by the test determine unit; conversely, the test determine unit determines that the quality of the projective mask does not meet the requirement.

Optionally, the figure analysis unit comprises:

a figure comparison unit, configured for exposure simulation for the defect figure and the target design figure, and obtaining a defect simulated exposure figure of the projective mask and a simulated exposure figure of the target design figure;

a bias proportion calculation unit, configured for obtaining a ratio, as the bias proportion, of the critical size of the defect simulated exposure figure to critical size of the simulated exposure figure of the target design figure in the same position; and

a communication unit, configured for obtaining the defect figure of the projective mask from the figure capture unit, transmitting the defect figure of the projective mask to the figure comparison unit, transmitting the defect simulated exposure figure and the simulated exposure figure of the target design figure received from the figure comparison unit to the bias proportion calculation unit and transmitting the bias proportion received from the bias proportion unit to the test determine unit.

Optionally, the figure comparison unit comprises:

a figure format transfer unit, configured for transferring the defect figure into GDS (Graphic Data System) format, so as to compare the defect figure in GDS format and the target design figure;

a defect merge unit, configured for merging the defect figure in GDS format received from the figure format transfer unit into the target design figure to obtain a defect figure in GDS format;

an exposure parameters storage unit, configured for storing simulated exposure parameters for the exposure simulation; and

an exposure simulation unit, configured for simulating exposure on the defect figure in GDS format and the target design figure according to the exposure parameters to obtain the defect simulated exposure figure and the simulated exposure figure of the target design figure.

Optionally, the exposure parameters comprise: a numerical aperture value and a sigma value.

Optionally, the simulated exposure parameters correspond to the projective mask and the target design figure.

Optionally, the figure capture unit comprises:

an optical module, configured for providing a light source;

a scanning module, configured for scanning the projective mask to be tested under the light source, so as to obtain the figure of the projective mask;

a figure processing module, configured for comparing the figure outputting from the scanning module and a reference figure in the figure processing module, so as to obtain the defect figure of the projective mask;

a figure storage unit, configured for storing the defect figure obtained from the figure processing module.

Optionally, the figure capture unit is a defect scanning equipment.

Optionally, the figure capture unit is a defect scanning equipment provided by KLA-Tencor Company.

Optionally, the test system for testing a projective mask further comprises: a target design figure storage unit, configured for storing different target design figures corresponding to different projective mask.

Optionally, the bias proportion is the ratio of the critical size of the patterns in one position of the projective mask to be tested to the critical size of the patterns in the same position of the target design figure.

Optionally, the maximum permitted bias proportion is ranged form 70% to 130%.

Compared with the prior art, the present invention has the following advantages.

The test system for testing a projective mask provided in embodiments of the present invention is configured for making an analysis based on the defect figures of the projective mask to be tested obtained by a figure capture unit and determining whether the quality of the projective mask to be tested meets the requirement based on the analysis result, so as to manage the test on the quality of projective masks and the evaluation defects on the projective masks.

Furthermore, the target design figure is in GDS format and the figure comparison unit comprises: the figure format transfer unit, the defect merge unit, the exposure parameters storage unit and the exposure simulation unit. The exposure simulation unit simulates exposure on the defect figure in GDS format and the target design figure according to numerical aperture value and sigma value, to obtain the defect simulated exposure figure and the simulated exposure figure of the target design figure which are more close to those under the practical photolithography process. Therefore, the test accuracy of the test system for testing a projective mask is improved.

### BRIEF DESCRIPTION OF THE DRAWINGS

FIG. 1 is a schematic structural diagram showing a test system for testing a projective mask according to an embodiment of the present invention; and

FIG. 2 is a practical exposure ISO CD (critical dimension) bar curve and a simulation exposure ISO CD bar curve of the projective mask, which is qualified according to the test system for testing a projective mask of the present invention.

### DETAILED DESCRIPTION OF THE INVENTION

In the prior art, the test system for testing a projective mask is very expensive, which increases the cost of quality test of the projective mask.

To solve the above problems, a test system for testing a projective mask is provided. The test system for testing a projective mask is capable of obtaining the defect figures of a projective mask, analyzing the defect figures, simulating a defect simulated exposure figure of the projective mask and then making an analysis of the defect simulated exposure figure of the projective mask and a simulated exposure figure of the target design figure, in order to determine whether the projective mask is qualified.

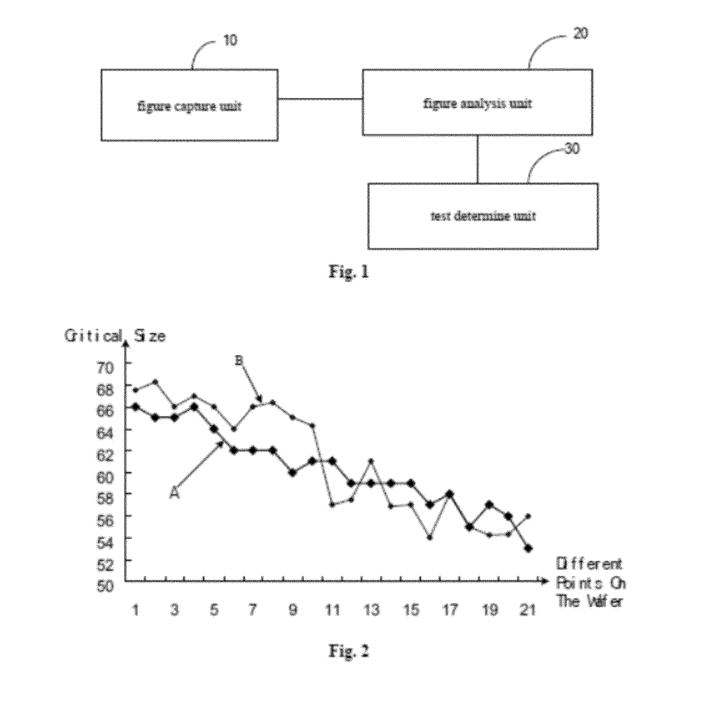

According to an embodiment of the present invention, a test system for testing a projective mask, illustrated as FIG. 1, is used for making an analysis based on the defect figures of the projective mask to be tested obtained by a figure capture unit 10 and determining whether the quality of the projective mask to be tested meets the requirement based on the analysis result. The test system for testing a projective mask comprises:

A figure analysis unit 20, configured for comparing the defect figure and the target design figure corresponding to the projective mask, and obtaining a bias proportion between the defect figure and the target design figure; and

A test determine unit 30, configured for comparing the bias proportion outputted by the figure analysis unit with a maximum permitted bias proportion, and making a determination, wherein if the outputted bias proportion does not exceed the maximum permitted bias proportion, a determination that the quality of the projective mask meets the requirement is made by the test determine unit; conversely, the test determine unit determines that the quality of the projective mask does not meets the requirement.

Optionally, the figure capture unit 10 comprises:

An optical module, configured for providing a light source;

A scanning module, configured for scanning the projective mask to be tested under the light source, so as to obtain the figure of the projective mask;

A figure processing module, configured for comparing the figure outputting from the scanning module and a reference figure in the figure processing module, so as to obtain the defect figure of the projective mask; and

A figure storage unit, configured for storing the defect figure obtained from the figure processing module.

The figure capture unit 10 is used to provide the defect figures of the projective mask to be tested to the figure analysis unit 20 of the test system. Optionally, the figure capture unit 20 can be a defect scanning equipment. Optionally, the figure capture unit 10 can be the defect scanning equipment provided by KLA-Tencor Company. Further, the figure capture unit 10 can be other equipments, which can make photos of the projective mask and obtain the defect figure of the projective mask. In order to make the test system of the present invention capable of testing various kinds of projective masks, optionally, the test system comprises a target design figure storage unit, configured for providing the target design figures, corresponding to different projective mask.

Optionally, the figure analysis unit 20 comprises:

A figure comparison unit, configured for exposure simulation for the defect figure and the target design figure, and obtaining a defect simulated exposure figure of the projective mask and a simulated exposure figure of the target design figure, and a bias proportion calculation unit, configured for obtaining a ratio, as the bias proportion, of the critical size of the defect simulated exposure figure to critical size of the simulated exposure figure of the target design figure in the same position; and

A communication unit, configured for obtaining the defect figure of the projective mask from the figure capture unit 10, transmitting the defect figure of the projective mask to the figure comparison unit, transmitting the defect simulated exposure figure and the simulated exposure figure of the target design figure received from the figure comparison unit to the bias proportion calculation unit and transmitting the bias proportion received from the bias proportion unit to the test determine unit.

In the embodiment, the target design figure is in GDS format. To transfer the defect figure into a figure with same format, GDS format, as the target design figure, the figure comparison unit comprises:

A figure format transfer unit, configured for transferring the defect figure into GDS format, so as to compare the defect figure in GDS format and the target design figure;

A defect merge unit, configured for merging the defect figure in GDS format received from the figure format transfer unit into the target design figure to obtain a merge defect figure in GDS format;

An exposure parameters storage unit, configured for storing simulated exposure parameters for the exposure simulation; and

An exposure simulation unit, configured for simulating exposure on the merge defect figure in GDS format and the target design figure according to the exposure parameters to obtain the defect simulated exposure figure and the simulated exposure figure of the target design figure.

Herein, the exposure parameters comprise the numerical aperture value of the optical lens and sigma value. The simulated exposure parameters correspond to the projective mask and the target design figure. The exposure parameters can be used to simulate the exposure process of the defect figure in GDS format and the target design figure to obtain the defect simulated exposure figures and the simulated exposure figure of the target design figure.

The bias proportion is a ratio of the critical size of the patterns in one position of the projective mask to be tested to the critical size of the patterns in the same position of the target design figure. The range of the maximum permitted bias proportion is 70% to 130%. Those skilled in the art can set more proper ranges of the maximum permitted bias proportion according to specific processes. Optionally, the maximum permitted bias proportion is ranged from 90% to 110%.

For validation, the projective mask, which turns out to be qualified according to the test system of an embodiment of the invention, is practically exposed on the wafer. As shown in FIG. 2, there are ISO CD bar curves according the practical exposure result of the projective mask qualified by the test system of embodiments of the invention and the simulated exposure result of the projective mask. Herein, curve A is the ISO CD bar curve, which is obtained by simulating the exposure process of the qualified projective mask verified by the test system of embodiments of the invention; curve B is the ISO CD bar curve, which is obtained by practically expose the qualified projective mask tested by the test system of embodiments of the invention on the wafer. It is obviously that curve A is close to curve B, and thus the analysis result of the defects of projective masks by the test system of embodiments of the invention corresponds to the defects by the practical exposure process. Therefore, the test result of the test system of embodiments of the invention is close to the result of practical process; the test system of embodiments of the invention is capable of testing defects of the projective masks and verifying whether the projective masks are qualified.

The test system of embodiments of the invention can be software programs, which may be installed in personal computers or may be stored in any storage mediums (e.g. U disk, magnetic disk etc.), so as to run flexibly in various computers without hardware requirements.

Thus, the provided test system for testing a projective mask, is configured for making an analysis based on the defect figures of the projective mask to be tested obtained by a figure capture unit and determining whether the quality of the projective mask to be tested meets the requirement based on the analysis result, so as to manage the test on the quality of projective masks and the evaluation defects on the projective masks.

Moreover, the target design figure is in GDS format. The figure comparison unit comprises: the figure format transfer unit, the defect merge unit, the exposure parameters storage unit and the exposure simulation unit. The exposure simulation unit simulates exposure on the defect figure in GDS format and the target design figure according to numerical aperture value and sigma value, to obtain the defect simulated exposure figure and the simulated exposure figure of the target design figure which are more close to those under the practical photolithography process. Therefore, the test accuracy of the test system for testing a projective mask is improved.

Although the present invention has been illustrated and described with reference to the preferred embodiments of the present invention, those ordinary skilled in the art shall appreciate that various modifications in form and detail may be made without departing from the spirit and scope of the invention.

What is claimed is:

1. A test system for testing a projective mask, configured for making analysis based on a defect figure of the projective mask to be tested obtained by a figure capture unit, comprising:
a figure analysis unit, configured for comparing the defect figure and a target design figure corresponding to the projective mask, and obtaining a bias proportion between the defect figure and the target design figure; and
a test determine unit, configured for comparing the bias proportion outputted by the figure analysis unit with a maximum permitted bias proportion, and making a determination, wherein if the outputted bias proportion does not exceed the maximum permitted bias proportion, a determination that the quality of the projective mask meets the requirement is made by the test determine unit; otherwise, the test determine unit determines that the quality of the projective mask does not meets the requirement.

2. The test system for testing a projective mask according to claim 1, wherein the figure analysis unit comprises:
a figure comparison unit, configured for performing a simulated exposure treatment on the defect figure and the target design figure, and obtaining a defect simulated exposure figure of the projective mask and a simulated exposure figure of the target design figure;
a bias proportion calculation unit, configured for obtaining a ratio, as the bias proportion, of the critical size of the defect simulated exposure figure to critical size of the simulated exposure figure of the target design figure in the same position; and
a communication unit, configured for obtaining the defect figure of the projective mask from the figure capture unit, transmitting the defect figure of the projective mask to the figure comparison unit, transmitting the defect simulated exposure figure and the simulated exposure figure of the target design figure received from the figure comparison unit to the bias proportion calculation unit and transmitting the bias proportion received from the bias proportion unit to the test determine unit.

3. The test system for testing a projective mask according to claim 2, wherein the target design figure is in GDS format and the figure comparison unit comprises:
a figure format transfer unit, configured for transferring the defect figure into GDS format, so as to compare the defect figure in GDS format and the target design figure;
a defect merge unit, configured for merging the defect figure in GDS format received from the figure format transfer unit into the target design figure to obtain a merge defect figure in GDS format;
an exposure parameters storage unit, configured for storing simulated exposure parameters for the exposure simulation; and
an exposure simulation unit, configured for simulating exposure on the merge defect figure in GDS format and the target design figure according to the exposure parameters to obtain the defect simulated exposure figure and the simulated exposure figure of the target design figure.

4. The test system for testing a projective mask according to claim 3, wherein the exposure parameters comprise: a numerical aperture value and sigma value.

5. The test system for testing a projective mask according to claim 3, wherein the simulated exposure parameters correspond to the projective mask and the target design figure.

6. The test system for testing a projective mask according to claim 1, wherein the figure capture unit comprises:
an optical module, configured for providing a light source;
a scanning module, configured for scanning the projective mask to be tested under the light source, so as to obtain the figure of the projective mask;
a figure processing module, configured for comparing the figure outputting from the scanning module and a reference figure in the figure processing module, so as to obtain the defect figure of the projective mask; and
a figure storage unit, configured for storing the defect figure obtained from the figure processing module.

7. The test system for testing a projective mask according to claim 6, wherein the figure capture unit comprises a defect scanning equipment.

8. The test system for testing a projective mask according to claim 7, wherein the figure capture unit comprises a defect scanning equipment provided by KLA-Tencor Company.

9. The test system for testing a projective mask according to claim 1, further comprising: a target design figure storage unit, configured for storing different target design figures corresponding to different projective masks.

10. The test system for testing a projective mask according to claim 1, wherein the bias proportion is a ratio of the critical size of patterns in one position of the projective mask to be tested to the critical size of patterns in the same position of the target design figure.

11. The test system for testing a projective mask according to claim 1, wherein the maximum permitted bias proportion ranges form 70% to 130%.
